(19) United States
(12) Patent Application Publication
(10) Pub. No.: US 2003/0072022 A1
(43) Pub. Date: Apr. 17, 2003

(54) Printing system, printer host and recording medium

(75) Inventor: Masahiro Someno, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/244,108

(22) Filed: Sep. 16, 2002

(30) Foreign Application Priority Data
Sep. 18, 2001 (JP) 2001-283852

(51) Int. Cl. H04N 1/50; H04N 1/56

(52) U.S. Cl. 358/1.13; 358/502; 358/530

(57) ABSTRACT

A printing system is provided, which comprises means for acquiring the number of ink colors of ink cartridges loaded on a printer; means for accepting print setting including designations regarding a printing medium and a quality of printing; and means for deciding, based on the acquired number of ink colors and a content of the accepted print setting, use of seven color inks or six color inks to perform printing. Thus, in the printing system capable of performing printing with using different numbers of ink colors, especially both of printing with using seven colors and printing with using six colors, without imposing any excessive burden on a user, a good result of printing can be obtained according to a type of the ink cartridge loaded on the printer, and a content of the print setting.

### TECHNICAL FIELD

The present invention relates to a printing system for carrying out color printing. More particularly, the present invention relates to a printing system capable of changing a combination of color inks used for printing.

### BACKGROUND ART

An ink jet printer, which includes an ink cartridge filled with ink, and carries out printing by spraying the ink from a printing head on a printing medium such as a recording form sheet, has gained in popularity. In particular, a color ink jet printer provided with a plurality of ink cartridges filled with color ink has been widely used.

Initially, for ink used for the color ink jet printer, three colors, i.e., three primary colors of yellow (Y), magenta (M) and cyan (C), were used. Also, in order to print black more clearly and cut back a total ink quantity, black (K) was often added to the three colors thereby to use four colors in total. Then, based on a combination of dots of these color inks, pseudo full color representation was obtained.

Then, in order to achieve printing with color gradation representation enhanced, and granular impression by dots eliminated, light color inks of light magenta (LM) and light cyan (LC) were added to carry out color printing by using six color inks.

Then, in recent years, to further enhance a quality of color printing, a color ink jet printer, which is added with dark yellow (DY), and carries out printing with seven colors has been proposed.

Incidentally, even in the case of the printer capable of printing with the seven colors, the colors other than the three primary colors, especially the dark yellow (DY) and the like, are used for enhancing the printing quality and, depending on a purpose of printing (e.g., fast printing or the like), or a type of a printing medium (e.g., sheet, in which an advantage of printing with the seven colors is difficult to be seen, or the like), printing may be carried out without using these colors.

Therefore, even in the case of the printer capable of printing with the seven colors, depending on a judgment of a user, frequently used color, for example, an ink cartridge of black (K) can be exchanged with an ink cartridge of dark yellow (DY) or the like, and the printing with the seven colors including dark yellow (DY) or the like, and the conventional printing with the six colors can be selectively carried out.

### DISCLOSURE OF THE INVENTION

Between the cases of the printing with the seven colors (7-color printing) and the printing with the six colors (6-color printing), a print processing content, for example, a look-up table which is referred to in color conversion processing for converting data of an RGB form into data of a CMYK form must be changed, and a control command which selects a printing head to discharge ink from a group of printing heads of the printer for discharging inks must be changed.

Thus, irrespective of loading of the 6-color ink on the printer, if print processing for 7-color printing is carried out, a result of printing different from planned color representation may be obtained. Also, irrespective of loading of the 7-color ink on the printer, if print processing for 6-color printing is carried out, a result of printing different from planned color representation may be obtained. Therefore, in conformity with the 7-color or 6-color ink loaded on the printer, print processing for 7-color or 6-color printing must be carried out.

On the other hand, depending on a content of print setting based on instructions from a user, for example a type of a printing medium, resolution of printing and the like, printing with the six colors is enough while printing with the seven colors is not necessary. In this case, preferably, printing should be carried out with the six colors even if 7-color ink is loaded.

Thus, whether to carry out the 7-color printing or the 6-color printing, must be judged by considering both a number of ink colors loaded on the printer and print setting.

However, if the judgment is entrusted to the user, an excessive burden will be imposed on the user. In addition, a misjudgment, an operation mistake or the like may occur, possibly causing a printing result different from planned color representation.

An object of the present invention is to provide a good printing result, in a printing system capable of performing printing operations using different number of color inks especially both seven color inks and six color inks, according to a number of ink colors loaded on a printer and a print setting content without imposing any excessive burden on a user.

In order to achieve the above-described object, according to a first aspect of the present invention, a printing system is provided, which can perform printing in a first printing mode for printing with using a plurality of ink colors, and a second printing mode for printing with using a greater number of ink colors than that of ink colors in the first printing mode, the printing system comprising:

ink cartridge loading means for loading ink cartridges containing ink;

number of ink color acquiring means for acquiring the number of ink colors of ink cartridges loaded by the ink cartridge loading means;

print setting accepting means for accepting print setting including designations regarding a printing medium and a quality of printing; and

printing mode deciding means for deciding which of the first and second printing modes is used to perform printing based on the number of ink colors acquired by the number of ink color acquiring means, and a content of print setting accepted by the print setting accepting means.

The printing mode deciding means may decide a printing data generating mode based on the number of ink colors acquired by the number of ink color acquiring means.

According to a second aspect of the present invention, a printer host is provided, which can generate printing data in a first printing data generating mode for generating printing data for printing with using a plurality of ink colors, and a second printing data generating mode for generating printing data for printing with using a greater number of ink colors than that of ink colors in the first printing data generating mode, the printer host comprising:

number of ink color acquiring means for acquiring the number of ink colors to be used by a printer to which the printer host outputs printing data;

print setting accepting means for accepting print setting including designations regarding a printing medium and a quality of printing; and

printing data generating mode deciding means for deciding, based on the number of ink colors acquired by the number of ink color acquiring means, and a content of print setting accepted by the print setting accepting means, which of the first and second printing data generating modes is used to generate printing data.

The printing data generating mode deciding means may decide a printing data generating mode based on the number of ink colors acquired by the number of ink color acquiring means.

In this case, the number of ink color acquiring means can investigate whether the number of ink colors can be acquired or not from the printer, to which the printer host outputs the printing data, acquire the number of color inks from the printer when acquisition is allowed, and prompt a user to enter the number of color inks and thereby acquire the number of color inks when acquisition is not allowed.

The printing data generating mode deciding means can decide a printing data generating mode in printing data generation processing.

In addition, the printing data generating mode deciding means can select the first printing data generating mode when the number of ink colors acquired by the number of ink color acquiring means is equal to the number of ink colors on the first printing data generating mode, determine whether a higher quality is required or not for the printing based on the content of the print setting accepted by the print setting accepting means when the number of ink colors acquired by the ink color acquiring means is equal to the number of ink colors in the second printing data generating mode, select the second printing data generating mode when it is determined that a higher quality is required for the printing, and select the first printing data generating mode when it is determined that no higher quality is required for the printing.

According to a third aspect of the present invention, a recording medium is provided, which records a printer driver for causing a computer to selectively execute printing data generation processing in a first printing data generating mode for generating printing data for printing with using a plurality of ink colors, and a second printing data generating mode for generating printing data for printing with using a greater number of ink colors than that of ink colors in the first printing data generating mode.

The printer driver causes the computer to execute number of ink color acquiring processing for acquiring the number of ink colors to be used by a printer, to which a printer host outputs printing data, print setting accepting processing for accepting print setting including designations regarding a printing medium and a quality of printing, and printing data generating mode deciding processing for deciding which of the first and second printing data generating modes is used to generate printing data based on the number of ink colors acquired in number of ink color acquiring processing, and a content of print setting accepted by the print setting accepting means.

In this case, the printing data generating mode deciding processing may decide a printing data generating mode based on the number of ink colors acquired in the number of ink color acquiring processing.

### BRIEF DESCRIPTION OF THE DRAWINGS

FIG. 1 is a block diagram showing an outline of a hardware configuration of a printing system according to the present invention.

FIG. 2 is a block diagram showing functional configurations realized by a computer 30 and a printer 10 of the printing system of the present embodiment.

FIG. 3 is a perspective view showing a printer engine.

FIG. 4A is a perspective view showing a schematic structure of an ink cartridge and a cartridge loading portion in a printer main body.

FIG. 4B is a perspective view showing a schematic structure of an ink cartridge and a cartridge loading portion in a printer main body.

FIG. 5 is a sectional view showing an internal structure of the ink cartridge, an internal structure of the cartridge loading portion on a carriage, and a situation of loading a cartridge on the cartridge loading portion.

FIG. 6 is a block diagram showing a configuration of a memory element installed in the ink cartridge.

FIG. 7 is a flowchart showing a processing operation when a printer driver 320 accepts a print setting request from a user.

FIG. 8 is a flowchart showing a processing operation when the printer driver 320 accepts a command of printing execution from the user.

FIG. 9 is a view showing an example of a user interface screen 500 for print setting.

FIG. 10 is a view showing an example of a user interface screen 510 for specific setting.

FIGS. 11A and 11B are views, each showing an example of a user interface screen 520 for setting an ink cartridge loaded on a 7th loading position: FIG. 11A showing an example where the printer 10 has no two-way communication function; and FIG. 11B an example where the printer 10 has a two-way communication function.

### BEST MODES FOR CARRYING OUT THE INVENTION

The preferred embodiments of the present invention will be described with reference to the accompanying drawings.

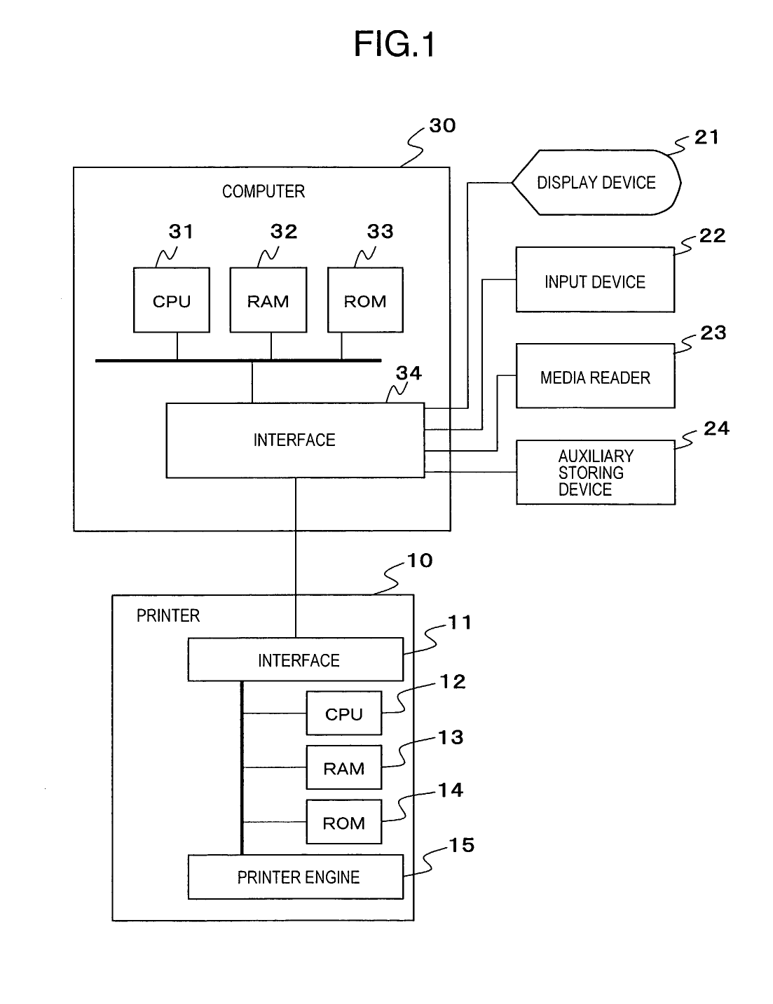

FIG. 1 is a block diagram showing an outline of a hardware configuration of a printing system according to the present invention.

As shown in FIG. 1, the printing system comprises a computer 30 for achieving various processing operations by applications, a print processing operation by a printer driver and the like, and a printer 10 connected to the computer 30. In the present embodiment, the computer 30 functions as a printer host for generating printing data, and sending it to the printer 10. The printer 10 carries out printing based on the printing data received from the computer 30. The printing system is not limited to this configuration. For example, a network printing system may be used, in which a plurality of computers 30 are connected.

The computer 30 includes Central Processing Unit (CPU) 31 for executing processing based on various programs, Random Access Memory (RAM) 32 for temporarily storing data and programs, Read Only Memory (ROM) 33 for nonvolatilely pre-storing various data for controlling the computer 30, programs for starting and the like, and an interface 34 for transferring data with a peripheral device such as the connected printer 10.

To the computer 30, connected are a display device 21 such as a color display, an input device 22 such as a mouse or a keyboard, a media reader 23 for reading data from a recording medium such as CD-ROM, and an internal or external auxiliary storing device 24. However, the computer 30 is not limited to this configuration.

The printer 10 is, for example, an ink jet color printer. The ink jet color printer includes a plurality of ink cartridges filled with ink in a case, and carries out printing by spraying the inks from a printing head on a printing medium such as a printing sheet.

The printer 10 includes an interface 11 for carrying out communications with the computer 30 such as receiving of data, a CPU 12 for executing processing based on various programs, a RAM 13 for temporarily storing printing data or the like, a ROM 14 for nonvolatilely pre-storing various data, various programs or the like for controlling the printer 10, and a printer engine 15. The printer engine 15 includes a printing head for discharging ink, a carriage driving mechanism for driving the carriage which loads the printing head, a paper feeding mechanism, a paper feeding/ejecting mechanism for feeding/ejecting paper, and the like. However, the printer 10 is not limited to this configuration.

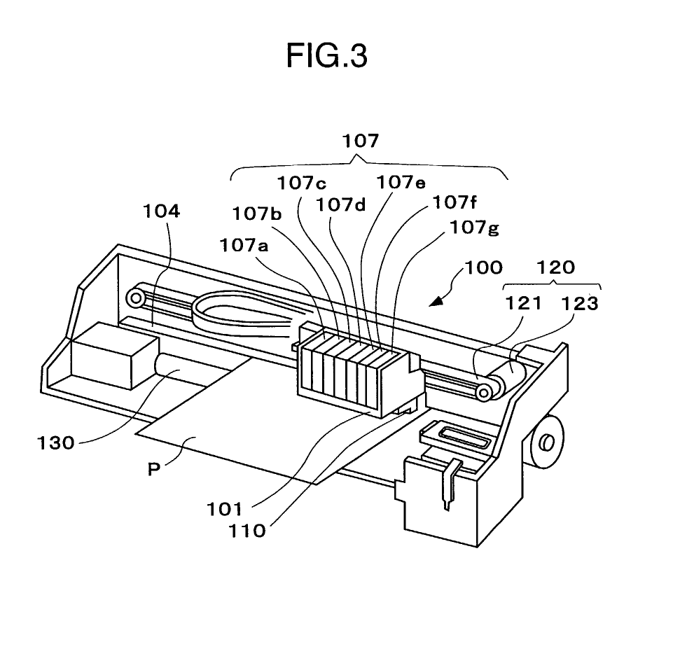

FIG. 3 shows an outline of a configuration of the printer engine 15. As shown in FIG. 3, the printer engine 15 includes a carriage 101 for loading a plurality of ink cartridges 107 (107a to 107g), an ink jet printing head 110 supported by the carriage 101, a carriage mechanism 120 for supporting the carriage 101 and reciprocating the same in a line direction, and a paper feeding mechanism 130 for feeding a sheet P.

The carriage mechanism 120 includes a timing belt 121 connected to the carriage 101, and a carriage motor 123 for reciprocating the timing belt 121. The carriage motor 123 reciprocates the carriage 101 in a width direction of a recording sheet P through the timing belt 121 while being guided by a guide member 104.

On the carriage 101, the ink jet printing head 110 is attached to a surface opposite the recording sheet P, i.e., an undersurface in the shown example. The printing head 110 is held on the carriage 101. The printing head 110 receives ink supplied from the ink cartridge 107, forms dots by discharging ink drops on the recording sheet P in response to a movement of the carriage 101, and then prints an image, characters or the like on the recording sheet P.

In this case, the ink cartridges 107a to 107g are independent of one another. An ink container formed in each ink cartridge is filled with a black (K) or colored ink. The colored ink can be selected from, for example cyan (C), light cyan (LC), magenta (M), light magenta (LM), yellow (Y), and dark yellow (DY).

According to the embodiment, it is designed so that seven ink cartridges 107 can be loaded on the carriage 101, and a black (K) or color ink cartridge 107 can be installed in each loading position.

A loading position of each cartridge is predetermined. For example, it is predetermined that in six loading positions out of seven, black (K), cyan (C), light cyan (LC), magenta (M), light magenta (LM), and yellow (Y) are set in this order, and that in the remaining one loading position (referred to as a 7th loading position for convenience) an ink cartridge of black (K) or dark yellow (DY) is set. This is for the purpose of enabling loading to be selectively carried out with frequently used black (K) depending on a judgment of a user, because the dark yellow (DY) is for increasing a quality of printing, and it is not always necessary depending on a purpose of printing, a type of a printing medium, or the like. As a result, when the dark yellow (DY) is set in the 7th loading position, printing with seven or six colors can be carried out. When the black (K) is set in the 7th loading position, printing with only six colors can be carried out.

On the printing head 110, nozzle openings (not shown) corresponding to the seven ink cartridges are arrayed for each row.

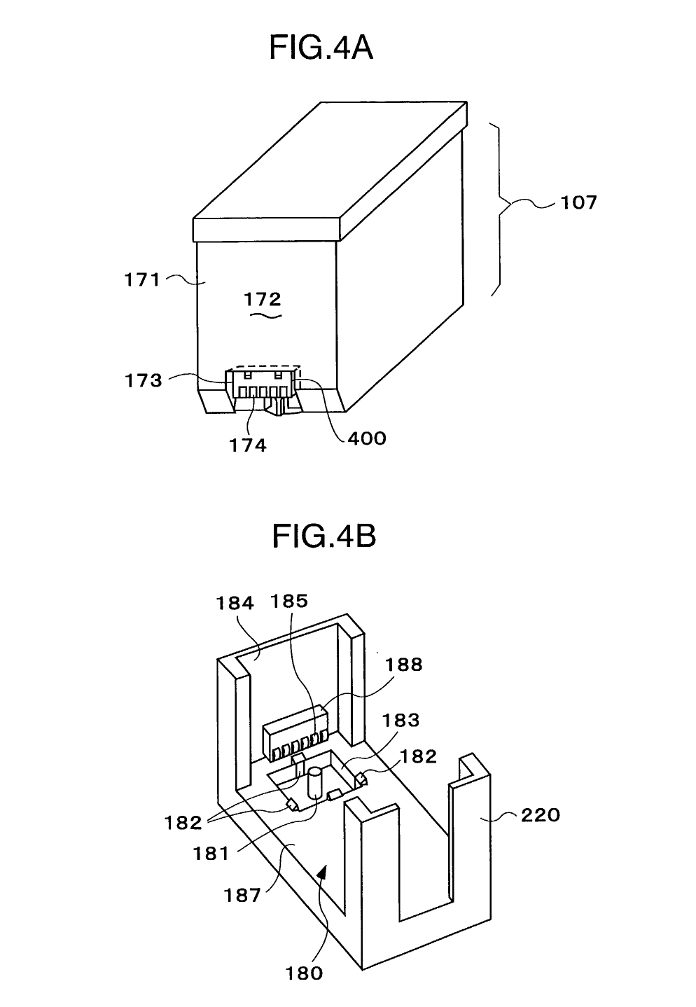

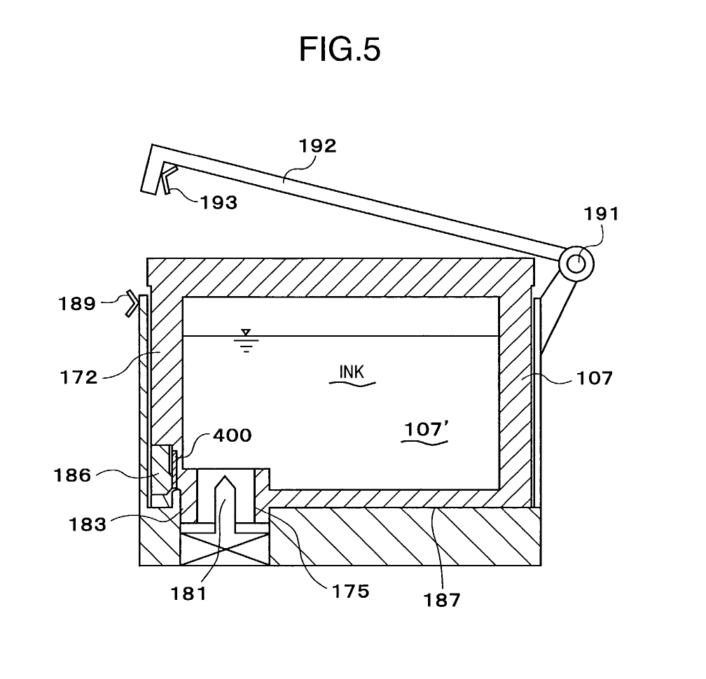

Next, description will be made for a structure of the ink cartridge 107, and a structure of loading the ink cartridge 107 on the printer 10 by referring to FIGS. 4A and 4B, and FIG. 5.

FIG. 4A is a perspective view schematically showing the structures of the ink cartridge 107 and FIG. 4B is the cartridge loading portion of the printer 10. FIG. 5 is a sectional view showing an internal structure of the ink cartridge 107, an internal structure of the cartridge loading portion on the carriage 101, and a situation of loading a cartridge on the cartridge loading portion.

In FIG. 4A, the ink cartridge 107 includes a cartridge main body 171 made of synthetic resin, which constitutes an ink container 107′ containing ink inside, and a memory element 400 incorporated in a side frame portion 172 of the cartridge main body 171. The memory element 400 transfers and receives various data with the printer 10 when the ink cartridge 107 is loaded on a cartridge loading portion 180 of the printer 10. Since the memory element 400 is installed in a concave portion 173 having a bottom side opened and located on the side frame portion 172 of the ink cartridge 107, only a plurality of connecting terminals 174 are exposed.

In FIG. 4B, in the cartridge loading portion 180, a needle 181 is arranged upward in a bottom portion 187 of a space for loading the ink cartridge 107. Around the needle 181, a concave portion 183 is formed to receive an ink supply portion 175 of the ink cartridge 107. Cartridge guide 182 are formed at respective three points on an inner wall of the concave portion 183. A connector 186 is arranged on an inner wall 184 of the cartridge loading portion. In the connector 186, a plurality of electrodes 185 are formed, to which the plurality of connecting terminals 174 of the memory element 400 are electrically connected when the ink cartridge 107 is loaded on the cartridge loading portion 180.

To load the ink cartridge 107 on the cartridge loading portion 180, as shown in FIG. 5, first, the ink cartridge 107 is arranged in the cartridge loading portion 180. Here, a fixed lever 192 is attached through a support shaft 191 to a rear wall portion 188 of the cartridge loading portion 180. By bringing down the fixed lever 192 so as to cover the ink cartridge 107, the ink cartridge 107 is pushed downward to fit the ink supply portion 175 in the concave portion 183. The needle 181 sticks the ink supply portion 175 to enable ink supplying. Further, by bringing down the fixed lever 192, a blocking portion 193 formed in a tip of the fixed lever 192 is hooked on an engaging tool 189 formed on the cartridge loading portion 180 so that the ink cartridge 107 is fixed. In this state, the plurality of connecting terminals 174 of the memory element 400 provided in the ink cartridge 107, and the plurality of electrodes 185 of the cartridge loading portion 180 are electrically interconnected, thus making it possible to transfer and receive data with the printer 100.

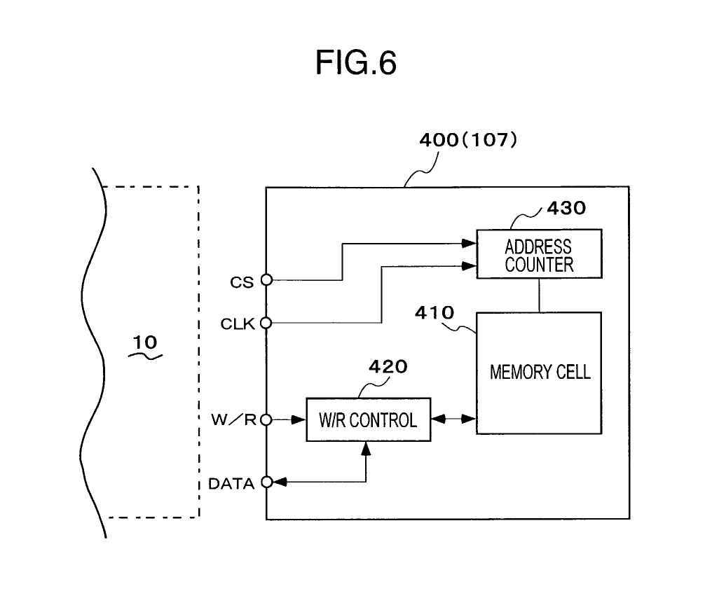

In the embodiment, as shown in the block diagram in FIG. 6, as the memory element 400, an EEPROM is used, which includes a memory cell 410, a read/write control unit 420 for controlling reading/writing of data in the memory cell 410, and an address counter 430 for executing counting-up when data is read/written between the printer 10 and the memory cell 410 through the read/write control unit 420 based on a clock signal CLK.

The memory cell 410 of the memory element 400 stores information indicating a color of ink filling the ink cartridge 107, and information indicating an ink residual quantity. The memory cell 410 may also store information regarding a type, a version, a manufacturer, a manufacturing time or the like of an ink cartridge.

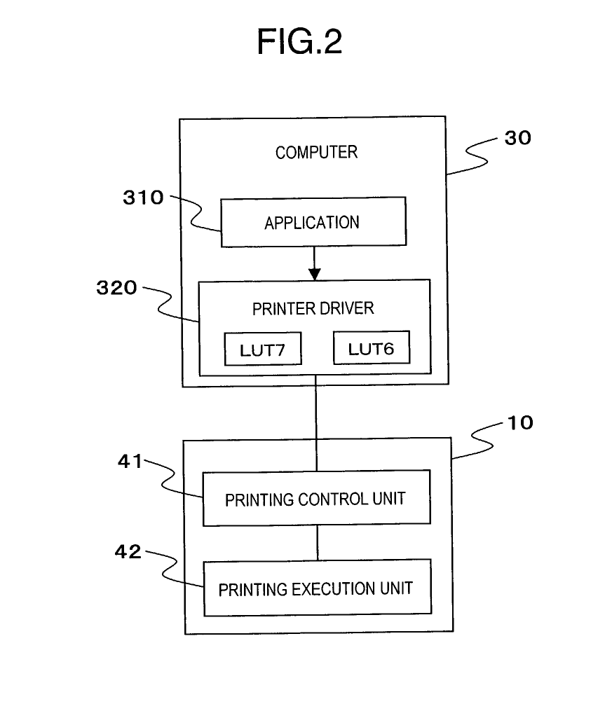

Next, description will be made for functional configurations realized by the computer 30 and the printer 10 in the above-described printing system by referring to a block diagram of FIG. 2.

As shown in FIG. 2, an application 310 and a printer driver 320 are constructed on the computer 30.

The application 310 has a function for causing the computer 30 to execute processing of a word processor, graphics or the like. The CPU 31 executes an application program read by the RAM 32, thereby constructing the application on the computer 30.

The printer driver 320 has a function to read image data generated by the application 310, to convert the image data read into printing data of a form to be interpreted by the printer 10, and to send the printing data through the interface 34 to the printer 10.

Accordingly, the printer driver 320 includes a rasterize processing portion for drawing image data composed of a printing command into dot-represented image data by a band unit, a halftone processing unit for executing color conversion processing and halftone processing for the image data, a command converting portion for creating printing data used to control the printer 10 so that the processed image data is printed at the printer 10, and a user interface unit (not shown) for accepting print setting from the user. In addition, a look-up table can be referred to in color conversion processing.

In the embodiment, the printer driver 320 at least includes a 7-color printing look-up table (LUT 7) using dark yellow (DY), and a 6-color printing look-up table (LUT 6) not using dark yellow (DY).

The printer driver 320 is constructed on the computer 30 in such a manner that the CPU 31 executes a printer driver program read by RAM 32. The printer driver program for this process can be distributed by, for example, being recorded on a portable recording medium such as a CD-ROM. Reading of this recording medium by the media reader 23 enables the printer driver program to be installed in the computer 30. The printer driver program can also be installed through a computer network such as Internet.

In FIG. 2, a print control unit 41 and a print execution unit 42 are constructed on the printer 10.

The print control unit 41 interprets the printing data sent from the computer 30, and controls the print execution unit 42 such that the printer 10 executes printing based on the printing data. If the printer 10 has a later-described two-way communication function, the print control unit 41 sends the information of the ink cartridges loaded on the printer 10 to the computer 30 in response to a request from the computer 30.

The printing execution unit 42 executes printing on the printing medium by the printer engine 15 according to an instruction of the printing control unit 41.

The printer generally has a function to receive the printing data from the compute 30. However, depending on a type of printer, a function which can send information regarding a state of the printer, the loaded ink cartridges or the like to the computer 30, so-called two-way communications is also available.

The present invention can be applied to both of the printer having a two-way communication function, and the printer having no such functions. Thus, in an explanation for a processing operation of the printing system below, a case where the printer 10 has the two-way communication function, and a case where thee printer 10 has no two-way communication functions are both assumed.

Here, whether a printer connected to the computer 30 has the two-way communication function or not can be determined, for example, in such a manner that the printer driver 320 refers to a predetermined module recorded in the RAM 32, the auxiliary storing device 24 or the like of the computer 30. Also, the computer 30 can determine if the printer has a two-way communication function by, for example, sending a predetermined signal to the printer 10. Here, when the computer 30 receives a predetermined response to the signal, it is determined that the printer 10 has two-way communication function.

Next, description will be made for a processing operation of the printing system of the present invention.

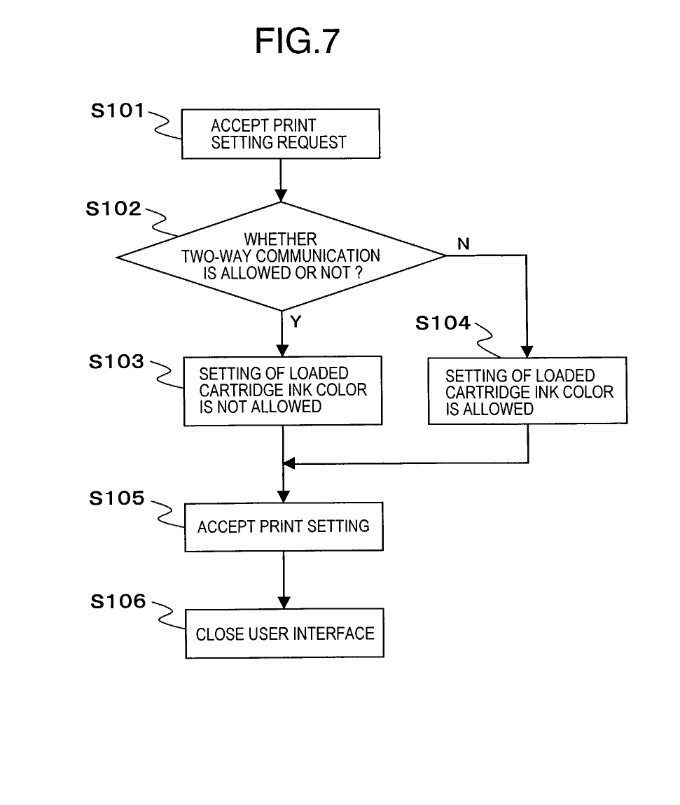

First, a processing operation when the printer driver 320 accepts a print setting request from a user is described by referring to a flowchart of FIG. 7.

Upon reception of a print setting request from a user through, for example, a menu command of the application 310 (S101), the printer driver 320 investigates whether the printer 10 used for printing has a two-way communication function or not (S102).

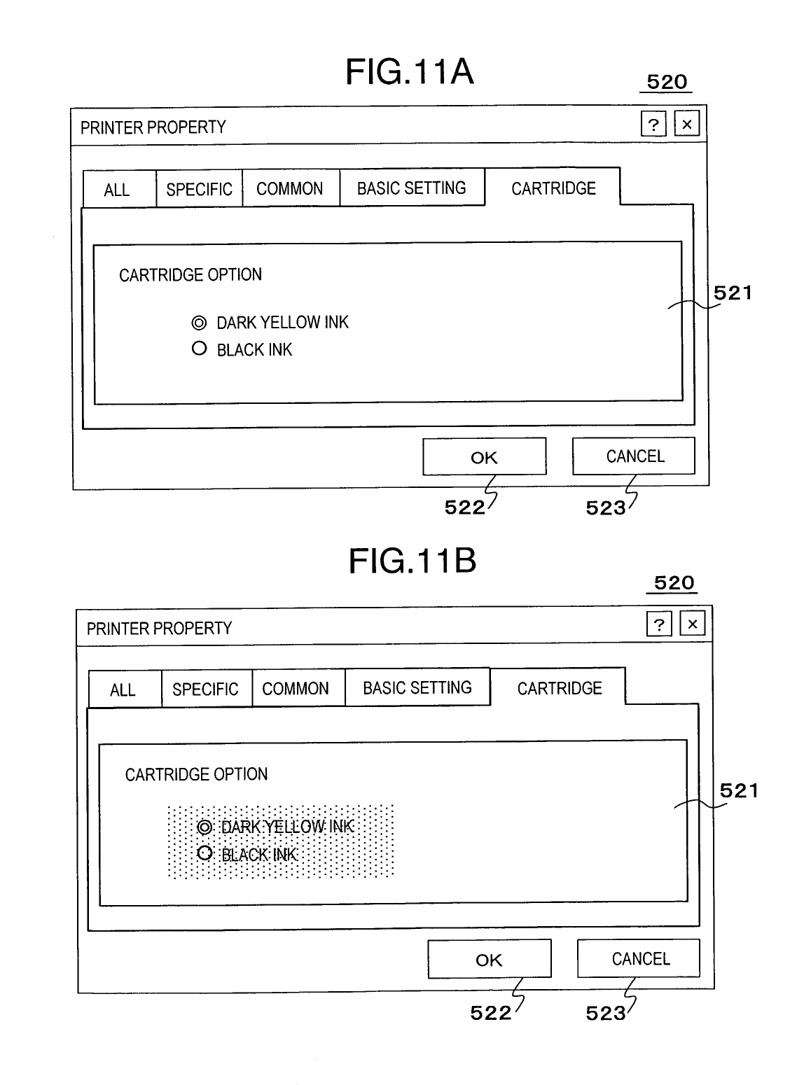

If a result of the investigation shows that the printer 10 has the two-way communication function, information indicating whether an ink cartridge set in a 7th loading position is seven colors or six colors can be obtained from the printer 10. Accordingly, it is not necessary to obtain from the user information indicating whether the ink cartridge set in the 7th loading position is black (K) or dark yellow (DY). Thus, a user interface (see FIG. 11B) is prepared, which inhibits the user from setting the color of the ink cartridge set in the 7th loading position (S103).

On the other hand, if the printer 10 has no two-way communication functions, information indicating whether the ink cartridge set in the 7th loading position is black (k) or dark yellow (DY) cannot be obtained from the printer 10. Accordingly, it is necessary to obtain from the user information regarding black (K) or dark yellow (DY) of the ink cartridge set in the 7th loading position. Thus, a user interface (see FIG. 11A) is prepared, which enables the user to set the color of the ink cartridge set in the 7th loading position (S104).

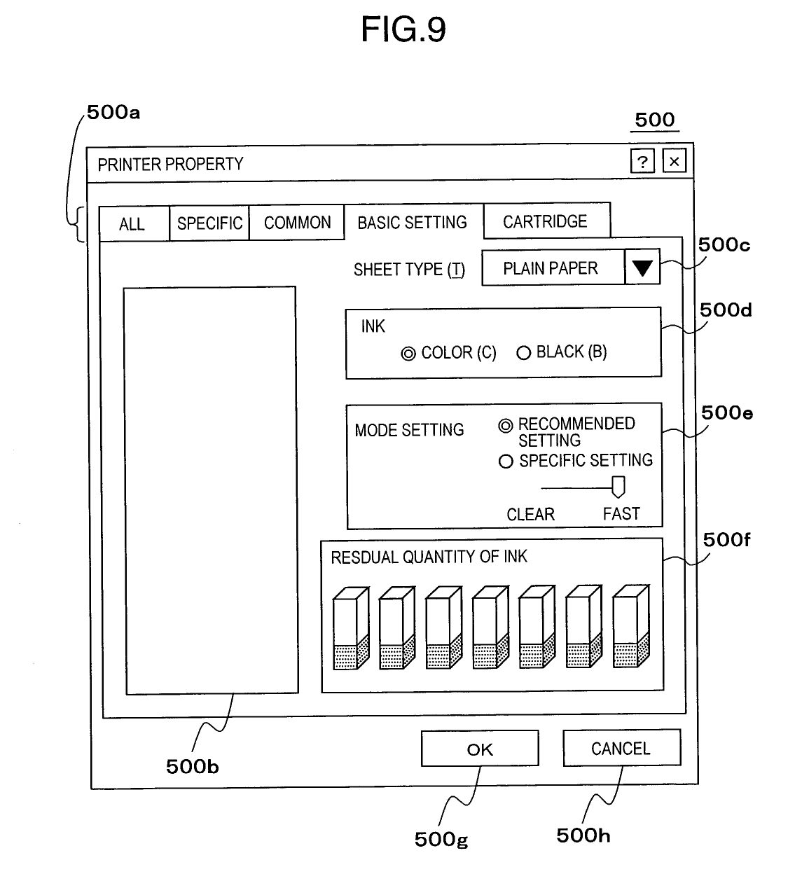

Then, the printer driver 320 displays a user interface screen 500 for print setting, as shown in FIG. 9 as an example, on the display device 21, and accepts print setting from the user (S105).

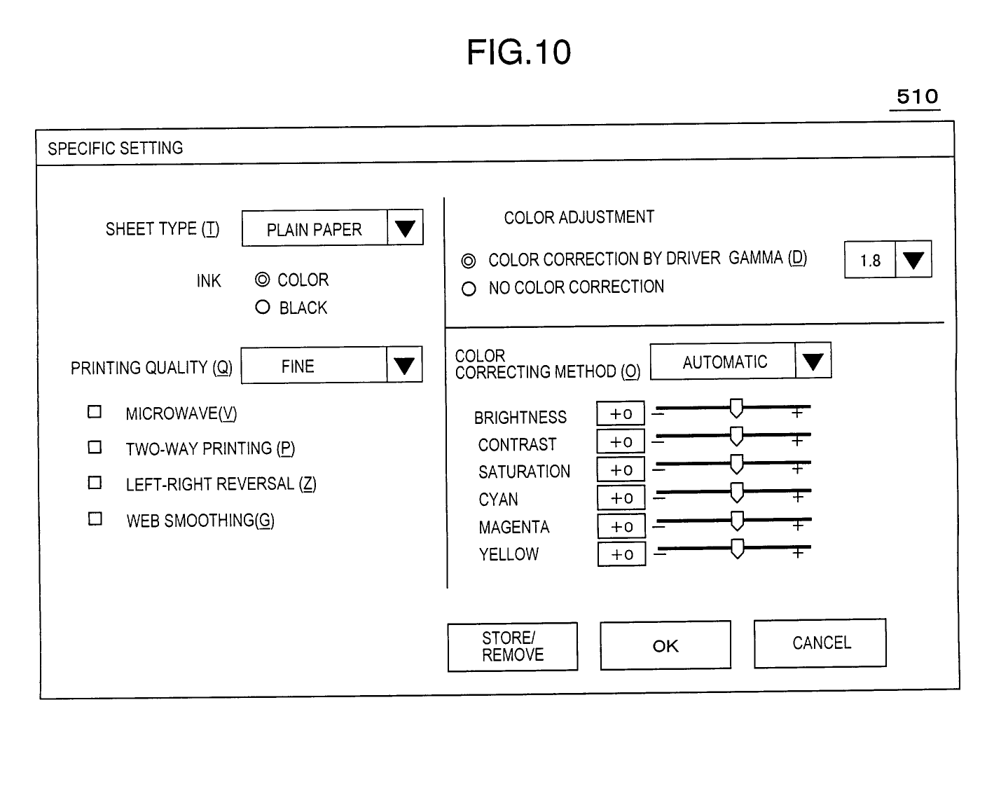

As shown in FIG. 9, the user interface screen 500 for print setting is the one for setting a basic content regarding print setting. For example, it can set a sheet type 500c, an ink mode 500d, a printing mode 500e, and the like. Here, the sheet type 500c, for example, plain paper, a post card, bond paper or the like, can be set by selecting from the menu. On the ink mode 500d, color or monochrome printing can be set. In mode setting, high-resolution or high-speed printing can be conveniently set and, by selecting a specific setting section, more specific setting regarding a quality of printing can be executed. That is, when the specific setting section is selected, the printer driver 320 displays a user interface screen 510 for specific setting, as shown in FIG. 10 as an example, on the display device 21. On this screen 510, the user can execute specific setting regarding a printing quality such as a printing quality mode, color adjustment, color correction, etc.

The screen 500 includes a tab portion 500a for displaying a setting screen for other items for printing, a section 500b for displaying a sheet size, a printing direction or the like, a section 500f for displaying a residual ink quantity of the printer 10, an “OK” button 500g for storing a setting content, and a “CANCEL” button 500h for canceling the setting content. However, if the printer 10 has no two-way communication function, and the printer driver 320 cannot obtain information of an ink cartridge loaded on the printer 10, then the section 500f for indicating a residual ink quantity is not displayed.

Upon acceptance of selection of “CARTRIDGE” on the tab portion 500a of the user interface screen 500 for print setting, the printer driver 320 displays a user interface screen 520 for setting the ink cartridge set in the 7th loading position on the display device 21. At this time, if the printer 10 has no two-way communication functions, the user interface screen prepared in step (S104), as shown in FIG. 11A as an example, is displayed. In a setting area 521 of the screen, the user can set a dark yellow or black ink of the ink cartridge set in the 7th loading position. If the printer 10 has a two-way communication function, the user interface screen prepared in step (S103), as shown in FIG. 11B as an example, is displayed. In a setting area 52 of the screen, ink cartridge setting is not allowed. Here, the method of displaying the user interface screen for setting the ink cartridge is not limited to the case where designation is accepted by the tab portion 500a. For example, if the printer 10 has no two-way communication functions, the user interface screen may be always displayed irrespective of the designation of the tab portion 500a. Alternatively, setting may be accepted on the other setting screen. If the printer 10 has a two-way communication function, the screen may not be displayed.

Upon reception of clicking of the “OK” button 500g on the user interface screen 500 for print setting, the printer driver 320 closes the user interface screen 500, and ends the print setting acceptance processing (S106).

The printer driver 320 temporarily stores information regarding the print setting set on the user interface screen 500 for print setting, the user interface screen 510 for specific setting, or the like, and prepares printing data by setting resolution of rasterization, a halftone processing method or the like, for example, according to the set content, in print processing carried out based on printing execution from the user.

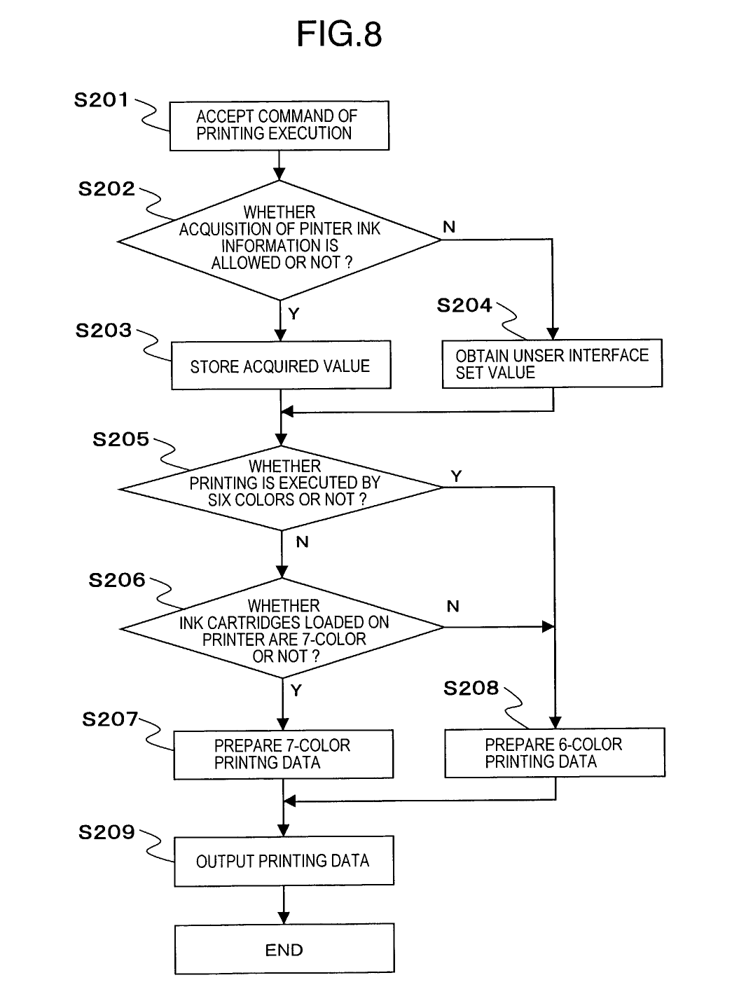

Next, a processing operation when the printer driver 320 accepts a command of printing execution from the user is described by referring to a flowchart of FIG. 8.

Upon reception of a command of printing execution from the user through, for example, the menu command of the application 310 (S201), the printer driver 320 investigates whether information of an ink cartridge set in the 7th loading position can be obtained or not from the printer 10 (S202). In this processing, if the printer 10 has a two-way communication function, the ink cartridge information can be obtained. If the printer 10 has no two-way communication functions, the ink cartridge information cannot be obtained.

As a result, if the ink cartridge information can be obtained, obtained information, i.e., if the ink cartridge is dark yellow (7 colors) or black (6 colors) is stored (S203).

On the other hand, if the ink cartridge information cannot be obtained, a value set on the user interface screen 520 for setting the ink cartridge set in the 7th loading position is obtained and stored (S204).

Then, by referring to the content set on the user interface screen 500f or print setting or the like, determination is made as to whether the printing is executed with six colors or not (S205). This is for the purpose of carrying out 6-color printing without executing 7-color printing, because for example when a sheet not so high in quality is set in the sheet type 500c, or setting with no high printing quality required is accepted on the printing mode 500d or on the user interface screen 510 for specific setting or the like, an advantage of 7-color printing is hard to be seen irrespective of loading of the 7-color ink cartridge. Thus, since processing time is generally smaller in 6-color printing than in 7-color printing, it is possible to shorten printing time.

Accordingly, with respect to determination as to whether the printing should be executed with six colors or not, a rule as to whether the printing is executed with six colors can be established beforehand according to, for example, the content of the sheet type 500c, the printing mode 500d, the user interface screen 510 for specific setting or the like. Then, determination can be made by referring to the rule and the print setting content accepted in the print setting processing.

As a result, if it is determined that the printing is carried out with six colors, processing is executed to prepare printing data for 6-color printing (S208). That is, color conversion processing is carried out by referring to the 6-color printing look-up table (LUT 6), and printing data is prepared by using a command to discharge ink from the printing head corresponding to the 6 color ink cartridges of the printer 10.

On the other hand, if it is determined that the printing is not executed with six colors, but can be executed with seven colors, determination is made as to whether the ink cartridges loaded on the printer 10 is 7-color or not (S206). That is, if the printer 10 has a two-way communication function, when the ink cartridge set in the 7th loading position stored in step (S203), is dark yellow (DY), the ink cartridges loaded on the printer 10 are determined to be 7 color cartridges. If the printer 10 has no two-way communication functions, when the ink color set by the user in step (S204) is dark yellow (DY), the ink cartridges loaded on the printer 10 are determined to be 7 color cartridges.

As a result, if it is determined that the ink cartridges loaded on the printer 10 are 7 color cartridges, processing is executed to prepare printing data for 7-color printing (S207). That is, color conversion processing is carried out by referring to the 7-color printing look-up table (LUT 7), and printing data is prepared by using a command to discharge the ink from the printing head corresponding to the 7-color ink cartridges of the printer 10.

On the other hand, if it is determined that the ink cartridges loaded on the printer 10 are not 7 color but 6 color cartridges, processing is executed to prepare printing data for 6-color printing (S208).

After the preparation of the printing data for the 7-color or 6-color printing, the printer driver 320 outputs the prepared printing data to the printer 10 (S209).

Then, the printer 10 executes printing based on the accepted printing data, and outputs a result of the printing.

If the determination of step (S206) is carried out before step (S205) and if the ink cartridge loaded on the printer 10 is determined to be a 6-color cartridges, data for 6-color printing may be prepared irrespective of a content of print setting (S208).

If the ink cartridge information can be obtained from the printer 10 in step (S202), the printer system may be constituted such that not only the number of ink colors bus also the number of cartridges for each color is obtained and the number of colors used for printing is decided by considering these information.

Thus, according to the present invention, since determination as to whether the printing should be executed with seven colors or with six colors is not made at the time of print setting but at the time of printing execution, it is possible to prevent occurrence of inconformity between the ink cartridge loaded on the printer and the printing processing for preparing printing data.

The embodiment has been described by way of example where the present invention is applied to the printing system capable of performing 6-color and 7-color printing. However, the invention is not limited to this example, but it can be applied to other printing systems capable of combining multicolor printing operations.

As described above, according to the present invention, in the printing system capable of performing printing using different numbers of ink colors, especially both 7-color and 6-color printing, it is possible to obtain a good printing result according to a type of an ink cartridge loaded on the printer and a print setting content without imposing any excessive burden on the user.

What is claimed is:

1. A printing system capable of performing printing in a first printing mode for printing with using a plurality of ink colors, and a second printing mode for printing with using a greater number of ink colors than that of ink colors in the first printing mode, comprising:
ink cartridge loading means for loading ink cartridges containing ink;
number of ink color acquiring means for acquiring the number of ink colors of ink cartridges loaded by the ink cartridge loading means; and
printing mode deciding means for deciding which of the first and second printing modes is used to perform printing based on the number of ink colors acquired by the number of ink color acquiring means.

2. A printing system capable of performing printing in a first printing mode for printing with using a plurality of ink colors, and a second printing mode for printing with using a greater number of ink colors than that of ink colors in the first printing mode, comprising:
ink cartridge loading means for loading ink cartridges containing ink;
number of ink color acquiring means for acquiring the number of ink colors of ink cartridges loaded by the ink cartridge loading means;
print setting accepting means for accepting print setting including designations regarding a printing medium and a quality of printing; and
printing mode deciding means for deciding which of the first and second printing modes is used to perform printing based on the number of ink colors acquired by the number of ink color acquiring means, and a content of print setting accepted by the print setting accepting means.

3. A printer host capable of generating printing data in a first printing data generating mode for generating printing data for printing with using a plurality of ink colors, and a second printing data generating mode for generating printing data for printing with using a greater number of ink colors than that of ink colors in the first printing data generating mode, comprising:
number of ink color acquiring means for acquiring the number of ink colors to be used by a printer to which the printer host outputs printing data; and
printing data generating mode deciding means for deciding which of the first and second printing data generating modes is used to generate printing data based on the number of ink colors acquired by the number of ink color acquiring means.

4. A printer host capable of generating printing data in a first printing data generating mode for generating printing data for printing with using a plurality of ink colors, and a second printing data generating mode for generating printing data for printing with using a greater number of ink colors than that of ink colors in the first printing data generating mode, comprising:
number of ink color acquiring means for acquiring the number of ink colors to be used by a printer to which the printer host outputs printing data;
print setting accepting means for accepting print setting including designations regarding a printing medium and a quality of printing; and
printing data generating mode deciding means for deciding which of the first and second printing data generating modes is used to generate printing data based on the number of ink colors acquired by the number of ink color acquiring means, and a content of print setting accepted by the print setting accepting means.

5. A printer host according to one of claims 3 and 4, wherein the number of ink color acquiring means investigates whether the number of ink colors can be acquired or not from the printer to which the printer host outputs the printing data, acquires the number of color inks from the printer when acquisition is allowed, and prompts a user to enter the number of color inks and thereby acquires the number of color inks when acquisition is not allowed.

6. A printer host according to one of claims 3 and 4, wherein the printing data generating mode deciding means decides a printing data generating mode in printing data generation processing.

7. A printer host according to claim 4, wherein the printing data generating mode deciding means selects the first printing data generating mode when the number of ink colors acquired by the number of ink color acquiring means is equal to the number of ink colors in the first printing data generating mode; determines based on the content of the print setting accepted by the print setting accepting means whether a higher quality is required or not for the printing when the number of ink colors acquired by the ink color acquiring means is equal to the number of ink colors on the second printing data generating mode; selects the second printing data generating mode when it is determined that a higher quality is required for the printing; and selects the first printing data generating mode when it is determined that no higher quality is required for the printing.

8. A recording medium recording a printer driver for causing a computer to selectively execute printing data generation processing in a first printing data generating mode for generating printing data for printing by using a plurality of ink colors, and a second printing data generating mode for generating printing data for printing by using a greater number of ink colors than that of ink colors on the first printing data generating mode,
the printer driver causing the computer to execute:
number of ink color acquiring processing for acquiring the number of ink colors to be used by a printer, to which a printer host outputs printing data; and
printing data generating mode deciding processing for deciding, based on the number of ink colors acquired in number of ink color acquiring processing, which of the first and second printing data generating modes is used to generate printing data.

9. A recording medium recording a printer driver for causing a computer to selectively execute printing data generation processing in a first printing data generating mode for generating printing data for printing with using a plurality of ink colors, and a second printing data generating mode for generating printing data for printing by using a greater number of ink colors than that of ink colors in the first printing data generating mode,
the printer driver causing the computer to execute:
number of ink color acquiring processing for acquiring the number of ink colors to be used by a printer to which a printer host outputs printing data;
print setting accepting processing for accepting print setting including designations regarding a printing medium and a quality of printing; and
printing data generating mode deciding processing for deciding which of the first and second printing data generating modes is used to generate printing data, based on the number of ink colors acquired in number of ink color acquiring processing, and a content of print setting accepted in print setting accepting processing.

10. A recording medium according to one of claims 8 and 9, wherein the ink color number acquiring processing investigates whether the number of ink colors can be acquired or not from the printer to which the printer host outputs the printing data, acquires the number of color inks from the printer when acquisition is allowed, and prompts a user to enter the number of color inks, thereby acquiring the number of color inks when acquisition is not allowed.

11. A recording medium according to one of claims 8 and 9, wherein the printing data generating mode deciding processing decides a printing data generating mode in printing data generation processing.

12. A recording medium according to claim 9, wherein the printing data generating mode deciding processing selects the first printing data generating mode when the number of ink colors acquired by the number of ink color acquiring processing is equal to the number of ink colors on the first printing data generating mode; determines whether a higher quality is required or not for the printing based on the content of the print setting accepted by the print setting accepting processing when the number of ink colors acquired by the ink color acquiring processing is equal to the number of ink colors on the second printing data generating mode; selects the second printing data generating mode when it is determined that a higher quality is required for the printing; and selects the first printing data generating mode when it is determined that no higher quality is required for the printing.
